(19) United States
(12) Patent Application Publication
(10) Pub. No.: US 2008/0035358 A1
(43) Pub. Date: Feb. 14, 2008

(54) Wheelbarrow plow

(76) Inventor: Richard C. Beasley, New Baden, TX (US)

Correspondence Address: JAMES RAY & ASSOCIATES, 2640 PITCAIRN ROAD, MONROEVILLE, PA, 15146, US

(21) Appl. No.: 11/503,060

(22) Filed: Aug. 11, 2006

(51) Int. Cl. A01B 13/08

(52) U.S. Cl. 172/699

(57) ABSTRACT

A plow apparatus which can be attached to the legs of a wheelbarrow adjacent a bottom surface thereof. Such plow apparatus includes a mounting member formed from a predetermined material. A first plurality of apertures are formed through such mounting member and a second plurality of apertures are formed through such legs of such wheelbarrow which are axially aligned with the first plurality apertures. A plow is attached to such mounting member for entering and moving earth. A securing device is engageable with each of such mounting member and such legs for securing the mounting member having the plow device attached thereto to such wheelbarrow.

### FIELD OF THE INVENTION

The present invention relates, in general, to residential type garden equipment and, more particularly, this invention relates to a wheelbarrow which can be readily converted into a plow type piece of residential garden equipment which can be used for turning the ground as well as for weeding between the crop rows.

### BACKGROUND OF THE INVENTION

Prior to the conception and development of the present invention, as is generally well known in the prior art, home gardeners have typically relied on shovels, spades, hoes, rakes, rototillers and other miscellaneous equipment required for gardening. Another piece of equipment often used in gardening is a wheelbarrow for hauling plants, dirt, water, fertilizers, stakes for staking plants and other equipment needed in tending to a garden.

While each of these particular devices work quite effectively for their intended purposes they are, nevertheless, individual pieces of equipment which must be purchased and maintained. In other words, these devices serve only a single purpose as opposed to being a multi-functional type piece of equipment. Furthermore, because these devices are individual pieces of equipment, they require additional storage space in either a shed, garage, or basement.

### SUMMARY OF THE INVENTION

The present invention provides an apparatus for providing multiple purposes to a home gardener. Such apparatus comprises a wheelbarrow, a plow and a means for securing such plow to such wheel barrow.

### OBJECTS OF THE INVENTION

It is, therefore, one of the primary objects of the present invention to provide a home gardening type apparatus which can be utilized to perform a plurality of gardening functions which formally required additional equipment.

Another object of the present invention is to provide a home gardening apparatus which will save valuable residential storage space.

Still another object of the present invention is to provide a home gardening apparatus which will require less maintenance.

Yet another object of the present invention is to provide a home gardening apparatus which will reduce equipment cost for a gardener.

A further object of the present invention is to provide a home gardening apparatus which can be utilized in an additional function of removing dirt from drainage ditches.

An additional object of the present invention is to provide a home gardening apparatus which is relatively easy to assemble for use as a plow.

In addition to the several objects and advantages of the present invention which have been described in specific detail above it should be noted that various other objects and advantages of the present invention will become more readily apparent to those persons skilled in the relevant art from the following more detailed description of the invention, particularly, when such description is taken in conjunction with the attached drawing figures and with the appended claims.

### BRIEF DESCRIPTION OF THE DRAWINGS

FIG. 1 is perspective view of a presently preferred embodiment of a plow mounting apparatus constructed according to the invention;

FIG. 2 is a perspective view of the plow mounting apparatus illustrated in FIG. 1 which is attached to the legs of a wheelbarrow; and

FIG. 3 is a partial perspective view of the apparatus as it is ready to use.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical reference functions have been identified with identical reference numerals throughout the several views illustrated in the attached drawing Figures.

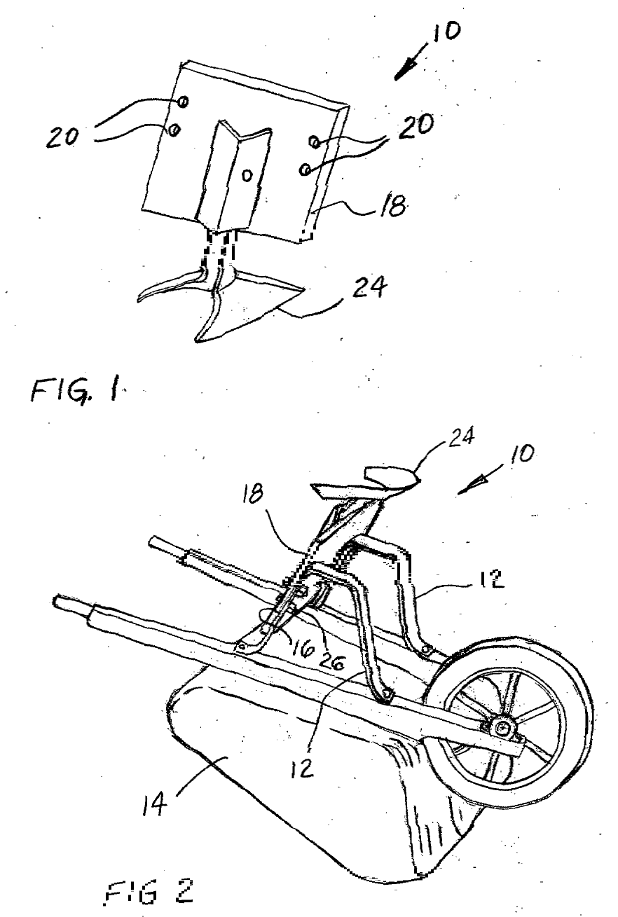

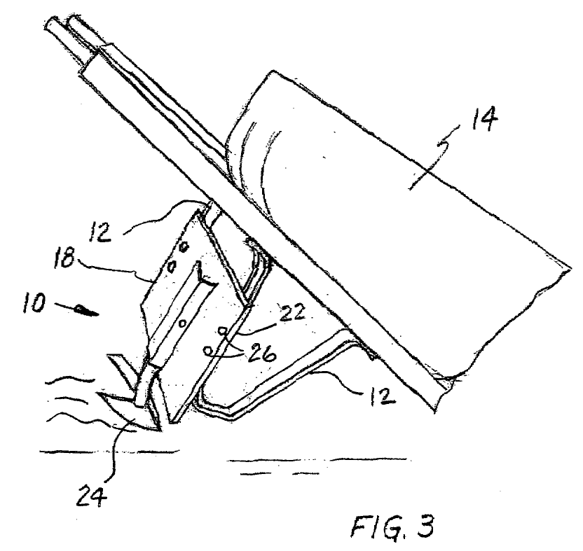

Now reference is made to FIGS. 1-3. Illustrated therein is a plow type device, generally designated 10, which can be attached to the legs 12 of a wheelbarrow 14 adjacent a bottom surface 16 thereof.

Such plow apparatus 10 includes a mounting member 18 having each of a predetermined length, a predetermined width and a predetermined depth. The mounting member 18 is formed from a predetermined material selected from the group consisting of wood, metal, engineered type plastic and various combinations thereof. The metal may be either aluminum or steel. the presently preferred material is wood due to it being both lightweight and less expensive.

In the presently preferred embodiment the mounting member 18 includes a first predetermined plurality of apertures 20, preferably four, formed therethrough. There is also a second predetermined plurality of apertures 22, also preferably four, formed through such legs 12 of wheelbarrow 14 which are axially aligned with the first predetermined plurality apertures 20 formed through the mounting member 18.

A plow means 24 is attached to the mounting member 18 for entering and moving earth. When such mounting member 18 is metal the plow means 24 will preferably be attached by welding.

A securing means, preferably bolts 26 is engageable with each of such mounting member 18 and such legs 12 for securing mounting member 18 having the plow means 24 attached thereto to such wheelbarrow 14. Such bolts 26 enabling plow apparatus 10 to be removed from such wheelbarrow 14 when desired.

While in accordance with the patent statutes both the presently preferred and a number of alternative embodiments of the invention have been described in sufficient detail to enable a person skilled in the art to make and use the same it should be noted that various other modifications and adaptations of the invention can be made without departing from the spirit of the invention or the scope of the appended claims.

I claim:

1. A plow apparatus which can be attached to legs of a wheelbarrow adjacent a bottom surface of such legs, said plow apparatus comprising:
(a) a mounting member having each of a predetermined length, a predetermined width and a predetermined depth, said mounting member formed from a predetermined material;
(b) a first plurality of apertures formed through said mounting member;
(c) a second plurality of apertures formed through such legs of such wheelbarrow which are axially aligned with said first plurality apertures formed through said mounting member;
(d) a plow means attached to said mounting member for entering and moving earth; and
(e) securing means engageable with each of said mounting member and such legs for securing said mounting member having said plow means attached thereto to such wheelbarrow, said securing means enabling said plow apparatus to be removed from such wheelbarrow when desired.

2. A plow apparatus, according to claim 1, wherein said securing means is a plurality of bolts disposed through said first plurality of apertures formed in said mounting member and said second plurality of apertures formed through such legs of such wheelbarrow.

3. A plow apparatus, according to claim 1, wherein said predetermined material said mounting member is formed from is one of wood, metal, engineered type plastic and various combinations thereof.

4. A plow apparatus, according to claim 1, wherein said predetermined material said mounting member is formed from is metal.

5. A plow apparatus, according to claim 4, wherein said metal is selected from the group consisting of aluminum and steel.

7. A plow apparatus, according to claim 4, wherein said metal is aluminum.

8. A plow apparatus, according to claim 1, wherein said first and said second plurality of apertures is four.

9. A plow apparatus, according to claim 1, wherein said plow means is a double bladed plow.

10. A plow apparatus, according to claim 4, wherein said plow means is attached to said mounting member by welding.

11. In combination with a wheelbarrow, the improvement comprising a plow type apparatus engageable with legs of said wheelbarrow, said plow type apparatus including:
(a) a mounting member having each of a predetermined length, a predetermined width and a predetermined depth, said mounting member formed from a predetermined material;
(b) a first plurality of apertures formed through said mounting member;
(c) a second plurality of apertures formed through said legs of said wheelbarrow which are axially aligned with said first plurality apertures formed through said mounting member;
(d) a plow means attached to said mounting member for entering and moving earth; and
(e) securing means engageable with each of said mounting member and said legs for securing said mounting member having said plow means attached thereto to said wheelbarrow, said securing means enabling said plow apparatus to be removed from said wheelbarrow when desired.
